(19) United States
(12) Patent Application Publication
(10) Pub. No.: US 2026/0227778 A1
(43) Pub. Date: Aug. 6, 2026

(54) REMOTE DRIVING SYSTEM, INFORMATION PROCESSING APPARATUS, AND INFORMATION PROCESSING METHOD

(71) Applicant: SONY GROUP CORPORATION, TOKYO (JP)

(72) Inventor: ATSUSHI YOSHIZAWA, TOKYO (JP)

(21) Appl. No.: 19/151,432

(22) PCT Filed: Jan. 18, 2024
(86) PCT No.: PCT/JP2024/001310

§ 371 Date: Jul. 28, 2025

(30) Foreign Application Priority Data
Feb. 6, 2023 (JP) 2023-016067

(51) Int. Cl. G05D 1/227; B60W 60/00

(52) U.S. Cl. CPC G05D 1/2279; B60W 60/001; B60W 2556/10; B60W 2556/45; B60W 2756/10

(57) ABSTRACT

To enable a remote driver to be favorably determined.

A processor that determines a remote driver who remotely drives a remote driving target vehicle is provided. Processing in the processor includes first processing of selecting one remote driver group from one or more remote driver groups including at least one remote driver and second processing of selecting one remote driver from the one remote driver group. It is possible to favorably determine the remote driver, rather than directly determining one remote driver from a large number of remote drivers.

### TECHNICAL FIELD

The present technology relates to a remote driving system, an information processing apparatus, and an information processing method and more particularly relates to a remote driving system and the like with a function of determining a remote driver.

### BACKGROUND ART

The spread and expansion of automated driving technologies are expected in the future due to advances in sensing technologies and artificial intelligence (AI) technologies. In order to achieve this, it is not only necessary to improve vehicles, but also to improve infrastructure and systems, for example, through the installation of high-speed, highly reliable communication systems, roads with advanced functions, and information processing centers.

In this manner, the spread and expansion of automated driving technologies are expected. However, due to the uncertainty of AI's behavior in the face of unknown problems, there are still some who remain deeply skeptical about the realization of fully automated driving. In other words, there is the idea that vehicles that perform automated driving will require some kind of human intervention in the event of unexpected events that can occur very rarely.

For example, there may be a preceding vehicle that maliciously and irregularly obstructs the path of an automatically driven vehicle. If the atypical behavior of this preceding vehicle exceeds the scope of the AI's learning, it may interfere with the continuation of the automated driving. In this case, remote driving support will be useful.

In some cases, it may be necessary to change the remote driver for some reason. For example, if a remote driver experiences a health problem during the remote driving, it may be necessary to change to another remote driver. Moreover, for example, if the quality of the communication line of a remote driver decreases during the remote driving, it may be necessary to change to another remote driver.

Moreover, in a case where there is a remote driver who is more technically suited to solving a problem that has arisen during the remote driving of a remote driver, it may be necessary to change to the other remote driver. Moreover, for example, in a case where it is necessary to change to another remote driver simply due to system-related reasons during the remote driving of a remote driver.

For example, Patent Literature 1 has disclosed a technology that attempts to reduce the burden on each individual's task by dividing the entire route requiring remote driving into a plurality of sections in advance and assigning them to a plurality of remote drivers. Moreover, for example, Patent Literature 2 has disclosed a technology that assigns remote drivers in accordance with the length of the waiting time and the time involved in remote driving during the assignment of remote drivers.

### CITATION LIST

### Patent Literature

Patent Literature 1: Japanese Patent Application Laid-open No. 2021-015378
Patent Literature 2: Japanese Patent Application Laid-open No. 2018-142265

### DISCLOSURE OF INVENTION

### Technical Problem It is an objective of the present technology to enable a remote driver to be favorably determined.

### Solution to Problem

A concept of the present technology is
in a remote driving system including
a processor that determines a remote driver who remotely drives a remote driving target vehicle, in which
processing in the processor includes first processing of selecting one remote driver group from one or more remote driver groups including at least one remote driver and second processing of selecting one remote driver from the one remote driver group.

In the present technology, it includes the processor that determines the remote driver who remotely drives the remote driving target vehicle. The processor determines the remote driver who remotely drives the remote driving target vehicle.

Here, the processing in the processor includes the first processing of selecting one remote driver group from one or more remote driver groups including at least one remote driver and the second processing of selecting one remote driver from the one remote driver group.

For example, sensor information and operation information of the remote driving target vehicle at a time of remote driving of a remote driver determined in the processor may be shared with a remote driving group including the remote driver. This enables the other remote drivers included in the remote driving group including that remote driver to easily know the current remote driving state, and to, for example, when taking over the remote driving, quickly know the remote driving state and smoothly take it over.

Moreover, for example, in the first processing, the one remote driver group may be selected on the basis of either one or both of sensor information and operation information of the remote driving target vehicle. Accordingly, it is possible to select a remote driver group including a remote driver suitable for the surrounding state and the vehicle state of the remote driving target vehicle.

In this case, for example, when the remote driving target vehicle includes a plurality of remote driving target vehicles, a typical value of sensor information of the plurality of remote driving target vehicles may be used as the sensor information. Moreover, in this case, for example, when the remote driving target vehicle includes a plurality of remote driving target vehicles, a typical value of operation information in the plurality of remote driving target vehicles may be used as the operation information. Here, the typical value is a minimum value, a maximum value, an average value, a median value, a mode value, or the like. Accordingly, even when the remote driving target vehicle includes a plurality of remote driving target vehicles, it is possible to select a remote driver group including a remote driver suitable for the surrounding states and the vehicle states of the remote driving target vehicles.

Moreover, in this case, for example, the sensor information may be information about any one of a vehicle position change over time, a maximum number of vehicles, an average number of vehicles, a minimum vehicle-to-vehicle distance, an average vehicle-to-vehicle distance, a relative speed distribution change over time, a maximum relative speed value, an estimated vehicle type, or a rough vehicle body shape of a surrounding vehicle, a guardrail position, a signal position, or a stop line position, which is acquired by any one of a camera, a radar, or a LiDAR of the remote driving target vehicle or by a combination thereof, or information about any combination thereof.

Moreover, in this case, for example, the operation information may be information about any one of a speed history, an acceleration history, a steering operation history, an accelerator operation history, a brake operation history, a history of engine revolutions per minute, an engine temperature history, a remaining amount of fuel or battery charge, an estimated load weight value, a vehicle body size, or a vehicle body shape of the remote driving target vehicle or information about any combination thereof.

Moreover, for example, in the second processing, the one remote driver may be selected on the basis of information related to each remote driver included in the one remote driver group. In this case, for example, the information related to the remote driver may be information about any one of connection information, health information, or work information of the remote driver or information about any combination thereof. Accordingly, it is possible to select the best remote driver for remotely driving the remote driving target vehicle.

Moreover, for example, the processor may determine, when a remote driving request is made from the remote driving target vehicle, a remote driver who remotely drives the remote driving target vehicle. Accordingly, when a remote driving request is made from the remote driving target vehicle, it is possible to favorably determine a remote driver who remotely drives a remote driving target vehicle and to remotely drive the remote driving vehicle.

Moreover, for example, the processor may determine, when an abnormality in driving of the remote driving target vehicle is detected, a remote driver who remotely drives the remote driving target vehicle. Accordingly, when an abnormality in driving of the remote driving target vehicle is detected, it is possible to favorably determine a remote driver who remotely drives a remote driving target vehicle and to remotely drive the remote driving vehicle.

Moreover, for example, the processor may determine, when a remote driver change request is made from a first remote driver who is remotely driving the remote driving target vehicle, a second remote driver that remotely drives the remote driving target vehicle. Accordingly, it is possible to favorably change the remote driver.

In this case, for example, the processor may perform the first processing of selecting one remote driver group from one or more remote driver groups including at least one remote driver and the second processing of selecting one remote driver from the one remote driver group, thereby determining the second remote driver. Accordingly, it is possible to determine the second remote driver suitable for the surrounding state and the vehicle state of the remote driving target vehicle at the time of this change.

Moreover, in this case, for example, the processor may perform, when the first remote driver has been determined by performing the first processing of selecting one remote driver group from one or more remote driver groups including at least one remote driver and the second processing of selecting one remote driver from the one remote driver group, processing of selecting one remote driver different from the first remote driver from the remote driver group including the first remote driver, thereby determining the second remote driver. Accordingly, it is possible to omit the processing of selecting one remote driver group at the time of this change and to efficiently determine the second remote driver.

In this manner, in the present technology, the processor that determines the remote driver who remotely drives the remote driving target vehicle is provided, and the processing in this processor includes the first processing of selecting one remote driver group from one or more remote driver groups including at least one remote driver and the second processing of selecting one remote driver from the one remote driver group. It is possible to favorably determine the remote driver, rather than directly determining one remote driver from a large number of remote drivers.

Moreover, another concept of the present technology is in
an information processing apparatus including:
a first processor that selects one remote driver group from one or more remote driver groups including at least one remote driver; and
a second processor that selects one remote driver from the one remote driver group.

In the present technology, it includes the first processor and the second processor. By the first processor, the one remote driver group is selected from the one or more remote driver groups including the at least one remote driver. By the second processor, the one remote driver is selected from the one remote driver group.

For example, in the first processor, the one remote driver group may be selected on the basis of either one or both of sensor information and operation information of a remote driving target vehicle. Accordingly, it is possible to select a remote driver group including a remote driver suitable for the surrounding state and the vehicle state of the remote driving target vehicle.

Moreover, for example, in the second processor, the one remote driver may be selected on the basis of information related to each remote driver included in the one remote driver group. Accordingly, it is possible to select the best remote driver for remotely driving the remote driving target vehicle.

In this manner, in the present technology, the first processor that selects the one remote driver group from the one or more remote driver groups including the at least one remote driver and the second processor that selects the one remote driver from the one remote driver group are provided. It is possible to favorably determine the remote driver, rather than directly determining one remote driver from a large number of remote drivers.

Moreover, another concept of the present technology is in
an information processing method including:
a step of selecting one remote driver group from one or more remote driver groups including at least one remote driver; and
a step of selecting one remote driver from the one remote driver group.

### BRIEF DESCRIPTION OF DRAWINGS

FIG. 1 A block diagram showing an example of a system configuration for performing remote driving.

FIG. 2 A block diagram showing the example of the system configuration for performing remote driving.

FIG. 3 A sequence diagram showing an example of processing steps in the system configuration example shown in FIGS. 1 and 2.

FIG. 4 A block diagram showing an example of the system configuration for performing remote driving.

FIG. 5 A block diagram showing the example of the system configuration for performing remote driving.

FIG. 6 A block diagram showing a configuration example of a remote driver group determination unit.

FIG. 7 A block diagram showing a configuration example of a processor that determines a remote driver.

FIG. 8 A block diagram showing an example of supervised learning for configuring a remote driver group selection unit.

FIG. 9 A flowchart showing an example of processing steps of a remote driver selection unit.

FIG. 10 A sequence diagram showing an example of processing steps in the system configuration example shown in FIGS. 4 and 5.

FIG. 11 A diagram showing a remote driver change example due to a remote driver change.

FIG. 12 A block diagram showing a hardware configuration example of a remote driving system (computer).

FIG. 13 A sequence diagram showing another example of processing steps in the system configuration example shown in FIGS. 4 and 5.

### MODE(S) FOR CARRYING OUT THE INVENTION

Hereinafter, mode(s) for carrying out the invention (hereinafter, referred to as “embodiment(s) ”) will be described. It should be noted that the descriptions will be given in the following order.
1. Embodiment
   1-1. System Configuration Example for Remote Driving
      1-1-1. Processing Steps in System Configuration Example
   1-2. System Configuration Example for Remote Driving According to Present Technology
      1-2-1. Determination of Remote Driver Group
      1-2-2. Processing in Processor That Determines Remote Driver
      1-2-3. Configuration Example of Processor That Determines Remote Driver
      1-2-4. Processing Steps of Remote Driver Selection Unit
      1-2-5. Processing Steps in System Configuration Example
      1-2-6. Hardware Configuration Example of Remote Driving System
2. Modified Example
   2-1. Application to Case of Remotely Driving Vehicle Group
   2-2. Remote Driving Start Due to Driving Abnormality Detection of Remote Driving Vehicle

### 1. Embodiment

### 1-1. System Configuration Example for Remote Driving

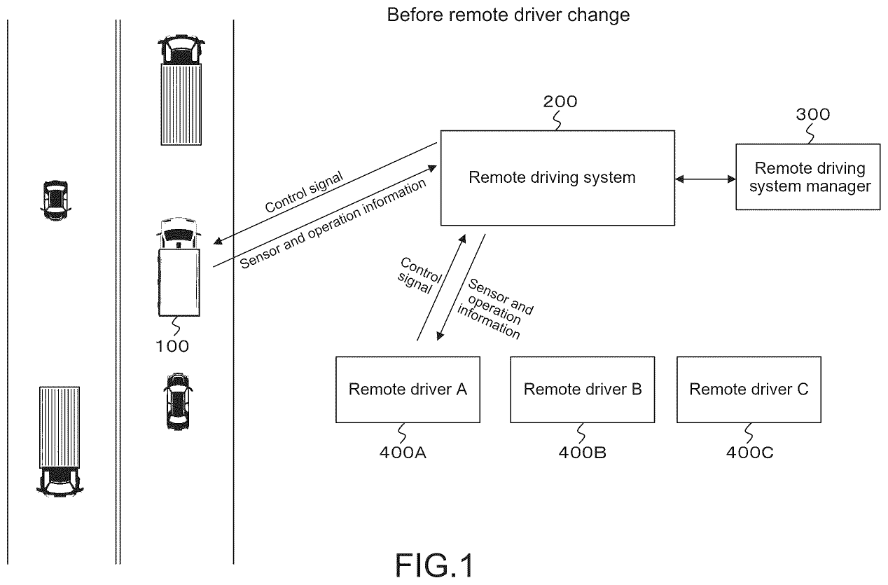

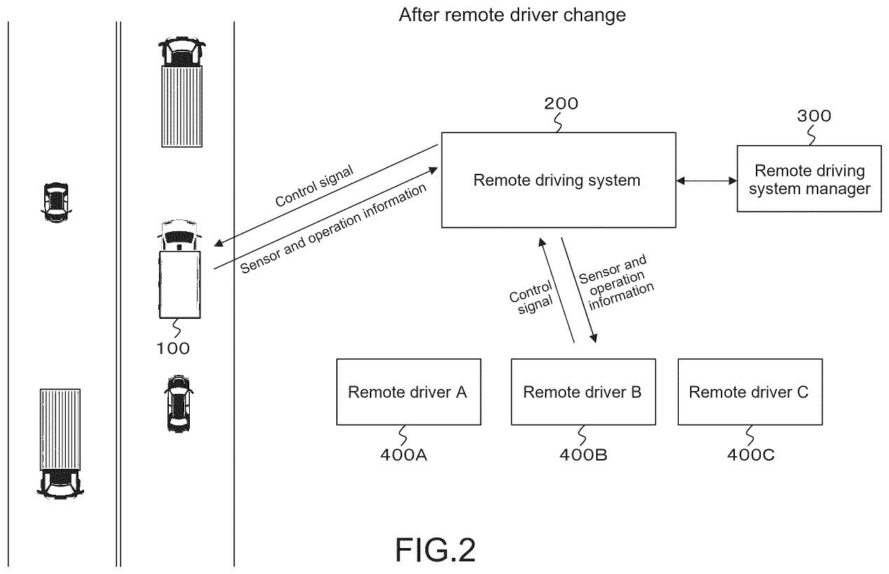

FIGS. 1 and 2 show an example of a system configuration for performing remote driving. A remote driving target vehicle 100 to be remotely driven is connected to a remote driving system 200 by wireless communication.

The wireless communication here may use a 4th generation (4G) network or 5th generation (5G) cellular system, Wi-Fi, a wireless system of dedicated short range communications (DSRC), or another certain dedicated wireless communication line, and it is not based on a particular method. Moreover, communication between remote drivers 400 (a remote driver 400A, a remote driver 400B, a remote driver 400C) and the remote driving system 200 is assumed to be either wired or wireless or both.

In this system configuration example, in the remote driving system 200, the remote driving of the remote driving target vehicle 100 is started in accordance with a remote driving start request associated with remote driver information from a remote driving system manager 300 to the remote driving system 200. Moreover, the remote driver is changed in accordance with a remote driver change request associated with remote driver information of a remote driver after the change from the remote driving system manager 300 to the remote driving system 200. It should be noted that FIG. 1 shows a state before the remote driver change in a case where the remote driver 400A is changed to the remote driver 400B. Moreover, FIG. 2 shows a state after the remote driver change in a case where the remote driver 400A is changed to the remote driver 400B.

The remote driver 400A and the remote driver 400B are agents for performing the same level task for the remote driving system manager 300. The remote driver 400A and the remote driver 400B are subjects who perform the remote driving belonging to the remote driving system 200. Before the remote driver change, the remote driver 400A is performing remote driving control on the remote driving target vehicle 100 via the remote driving system 200 on the basis of sensor and operation information obtained from the remote driving target vehicle 100 (see FIG. 1). Also, the remote driver 400B is performing remote driving control on the remote driving target vehicle 100 via the remote driving system 200 on the basis of sensor and operation information obtained from the remote driving target vehicle 100 (see FIG. 2).

### 1-1-1. Processing Steps in System Configuration Example

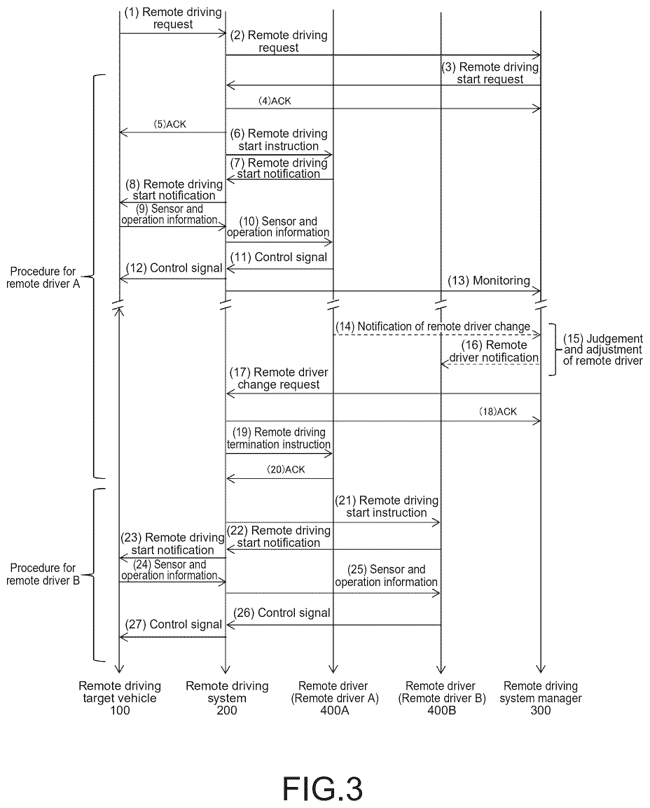

FIG. 3 is a sequence diagram showing an example of processing steps in the system configuration example shown in FIGS. 1 and 2. The example shown in the figure is an example in which the remote driving is started by sending a remote driving request from the remote driving target vehicle 100 to the remote driving system 200. It should be noted that although it is not described in detail, an example in which the remote driving is started on the basis of judgement of the remote driving system 200 or on the basis of a request from the remote driving system manager 300 can be considered in a similar way.

The sequence diagram in FIG. 3 will be described. First of all, a case where the remote driving is started will be described. (1) The remote driving target vehicle 100 sends a remote driving request to the remote driving system 200. (2) Subsequently, the remote driving system 200 that has received the remote driving request transfers the remote driving request to the remote driving system manager 300 (actually a terminal apparatus used by the remote driving system manager 300).

(3) Subsequently, the remote driving system manager 300 that has received the remote driving request selects a remote driver who should perform the remote driving from candidate remote drivers by performing judgement and adjustment as to the remote driver who should perform the remote driving multiple times, and then issues a remote driving start request to the remote driving system 200. At the same time, the remote driving start request indicates that the remote driver 400A is the remote driver who should perform the remote driving.

(4) Subsequently, the remote driving system 200 sends ACK back to the remote driving system manager 300. (5) Moreover, the remote driving system 200 that has received the remote driving start request sends ACK back to the remote driving target vehicle 100. (6) Subsequently, the remote driving system 200 sends a remote driving start instruction to the remote driver 400A (actually a terminal apparatus used by the remote driver 400A).

(7) Subsequently, the remote driver 400A that has received the remote driving start instruction sends a remote driving start notification to the remote driving system 200. (8) Subsequently, the remote driving system 200 that has received the remote driving start notification transfers the remote driving start notification to the remote driving target vehicle 100. (9) Subsequently, the remote driving target vehicle 100 that has received the remote driving start notification sends sensor information and operation information to the remote driving system 200.

(10) Subsequently, the remote driving system 200 that has received the sensor information and the operation information transfers the sensor information and the operation information to the remote driver 400A. This enables the remote driver 400A to obtain video footages, distance measurement information of the surrounding environment, and the like from the vehicle through sensors, such as cameras, radars, and LiDARs, provided in the remote driving target vehicle 100, for example.

(11) Subsequently, the remote driver 400A performs a remote driving operation by using the video footages, the distance measurement information of the surrounding environment, and the like from the vehicle, and sends a control signal based on it to the remote driving system 200. (12) Subsequently, the remote driving system 200 that has received the control signal from the remote driver 400A transfers the control signal to the remote driving target vehicle 100. Accordingly, the remote driver 400A performs the remote driving operation on the remote driving target vehicle 100.

Thereafter, although the illustration is omitted, the remote driver 400A receives the sensor information and the operation information from the remote driving target vehicle 100 via the remote driving system 200 and the remote driver 400A sends the control signal based on the remote driving operation to the remote driving target vehicle 100 via the remote driving system 200. Those operations are repeatedly performed. In this manner, the remote driver 400A continuously performs the remote driving of the remote driving target vehicle 100.

(13) During the continuation of the remote driving, the remote driving system 200 enables the remote driving system manager 300 to monitor the remote driving state. For example, the remote driving system 200 transfers the sensor information and the operation information sent from the remote driving target vehicle 100 also to the remote driving system manager 300. This enables the remote driving system manager 300 to know whether the remote driving of the remote driving target vehicle 100 by the remote driver 400A is suitably performed on the basis of, for example, the video footages, the distance measurement information of the surrounding environment, and the like from the vehicle.

Next, a case of changing the remote driver will be described. Here, a case where the remote driver 400A wishes to change the remote driver and another remote driver takes over the role is considered. (14) In this case, the remote driver 400A sends a remote driver change notification to the remote driving system manager 300. (15) Subsequently, the remote driving system manager 300 that has received the remote driver change notification selects a remote driver who should take it over from candidate remote drivers by performing judgement and adjustment as to the remote driver who should take it over multiple times. In this example, it is assumed that the remote driver 400B is determined as the remote driver who should take it over.

(16) Subsequently, the remote driving system manager 300 notifies the remote driver 400B of the remote driver notification, that is, takeover of the remote driver. (17) Moreover, the remote driving system manager 300 sends a remote driver change request to the remote driving system 200. At the same time, the remote driver change request indicates that the remote driver 400B is a remote driver after the change.

(18) Subsequently, the remote driving system 200 that has received the remote driver change request sends ACK back to the remote driving system manager 300. (19) Moreover, the remote driving system 200 that has received the remote driver change request sends a remote driving termination instruction to the remote driver 400A. (20) Subsequently, the remote driver 400A that has received the remote driving termination instruction sends ACK back to the remote driving system 200.

(21) Subsequently, the remote driving system 200 that has received the ACK from the remote driver 400A sends a remote driving start instruction to the remote driver 400B. (22) Subsequently, the remote driver 400B that has received the remote driving start instruction sends the remote driving start notification to the remote driving system 200. (23) Subsequently, the remote driving system 200 that has received the remote driving start notification transfers the remote driving start notification to the remote driving target vehicle 100. (24) Subsequently, the remote driving target vehicle 100 that has received the remote driving start notification sends the sensor information and the operation information to the remote driving system 200.

(25) Subsequently, the remote driving system 200 that has received the sensor information and the operation information transfers the sensor information and the operation information to the remote driver 400B. This enables the remote driver 400B to obtain the video footages, the distance measurement information of the surrounding environment, and the like from the vehicle through the sensors, such as cameras, radars, and LiDARs, provided in the remote driving target vehicle 100, for example.

(26) Subsequently, the remote driver 400B performs a remote driving operation by using the video footages, the distance measurement information of the surrounding environment, and the like from the vehicle, and sends a control signal based on it to the remote driving system 200. (27) Subsequently, the remote driving system 200 that has received the control signal from the remote driver 400B transfers the control signal to the remote driving vehicle 100. Accordingly, the remote driver 400B performs the remote driving operation on the remote driving target vehicle 100.

Thereafter, although the illustration is omitted, the remote driver 400B receives the sensor information and the operation information from the remote driving target vehicle 100 via the remote driving system 200 and the remote driver 400B sends the control signal based on the remote driving operation to the remote driving target vehicle 100 via the remote driving system 200. Those operations are repeatedly performed. In this manner, the remote driver 400B continuously performs the remote driving of the remote driving target vehicle 100.

In the system configuration for performing remote driving as shown in FIGS. 1 and 2, it is necessary for the remote driving system manager 300 to select, when the remote driving target vehicle 100 requests the remote driving, a remote driver who should perform the remote driving from the candidate remote drivers by performing judgement and adjustment as to the remote driver who should perform the remote driving multiple times, and select, when the remote driver notifies of the remote driver change, a remote driver who should take it over from the candidate remote drivers by performing judgement and adjustment as to the remote driver who should take it over multiple times. It makes the roles of the remote driving system manager 300 complicated.

There is a limit to the work that can be performed by the remote driving system manager 300. Therefore, it may be impossible for the remote driving system manager 300 to sufficiently cope with a plurality of remote driving requests and remote driver change notifications which may be generated at the same time. It should be noted that although it is also possible to monitor candidate remote drivers all the time to smoothly select a remote driver in a case where an unexpected remote driving request or remote driver change notification is made, physical and mental burdens on the remote driving system manager 300 may increase along with an increase in the number of remote drivers as candidate remote drivers.

### 1-2. System Configuration Example for Remote Driving According to Present Technology

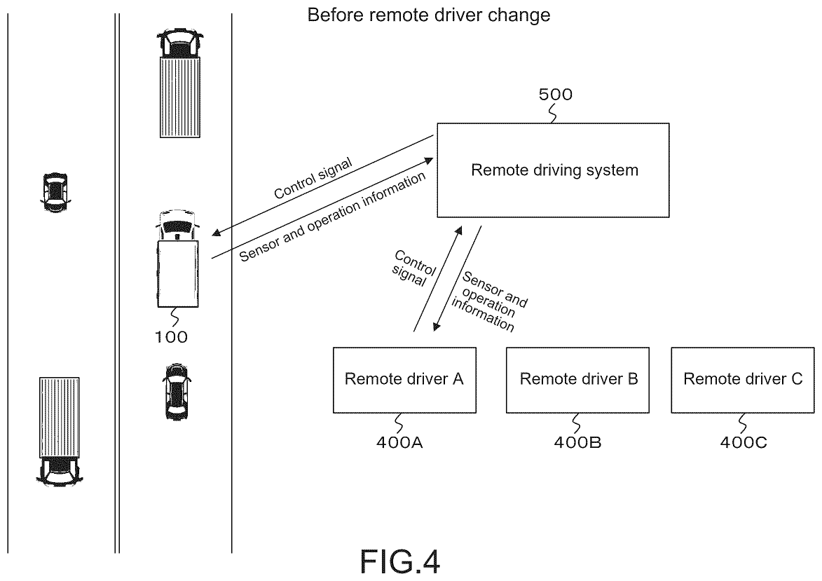

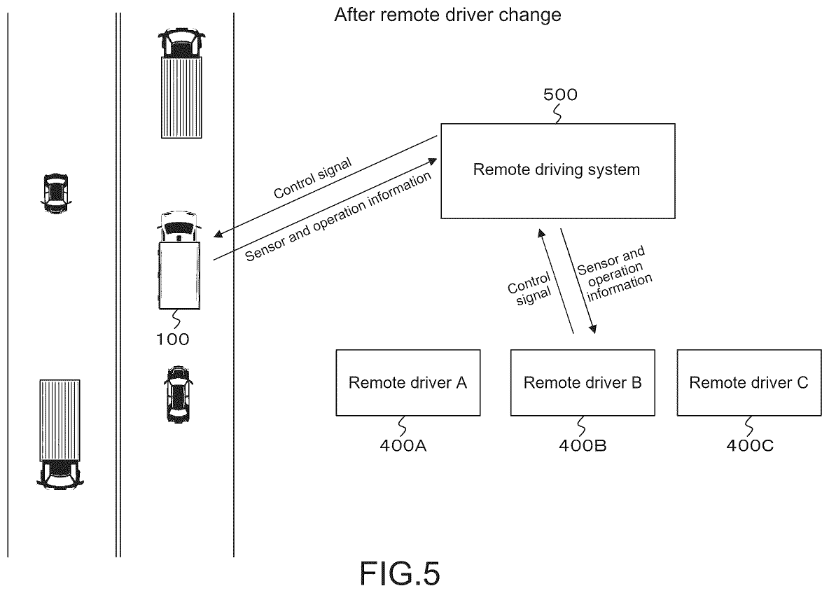

FIGS. 4 and 5 show an example of the system configuration for performing remote driving. In FIGS. 4 and 5, portions corresponding to FIGS. 1 and 2 will be denoted by the same reference signs and detailed descriptions thereof will be omitted as appropriate.

A remote driving target vehicle 100 to be remotely driven is connected to the remote driving system 500 by wireless communication.

The wireless communication here may use a 4th generation (4G) network or 5th generation (5G) cellular system, Wi-Fi, a wireless system of dedicated short range communications (DSRC), or another certain dedicated wireless communication line, and it is not based on a particular method. Moreover, communication between remote drivers 400 (a remote driver 400A, a remote driver 400B, a remote driver 400C) and the remote driving system 500 is assumed to be either wired or wireless or both.

In this system configuration example, in the remote driving system 500, in a case where a remote driving request is made from the remote driving target vehicle 100, a remote driver who should perform the remote driving is determined on the basis of either one or both of sensor information and operation information of that remote driving target vehicle 100, and the remote driving is started.

Moreover, in this system configuration example, in the remote driving system 500, in a case where a remote driver change request is made from the remote driver, a remote driver who should take it over is determined on the basis of either one or both the sensor information and the operation information of the remote driving target vehicle 100 being remotely driven, and the remote driver is changed. It should be noted that FIG. 4 shows a state before the remote driver change in a case where the remote driver 400A is changed to the remote driver 400B. Moreover, FIG. 5 shows a state after the remote driver change in a case where the remote driver 400A is changed to the remote driver 400B.

The remote driver 400A and the remote driver 400B are subjects who perform the remote driving belonging to the remote driving system 500. Before the remote driver change, the remote driver 400A is performing remote driving control on the remote driving target vehicle 100 via the remote driving system 500 on the basis of sensor and operation information obtained from the remote driving target vehicle 100 (see FIG. 4). Also, the remote driver 400B is performing remote driving control on the remote driving target vehicle 100 via the remote driving system 500 on the basis of sensor and operation information obtained from the remote driving target vehicle 100 (see FIG. 5).

The remote driving system 500 includes a processor that determines a remote driver who remotely drives the remote driving target vehicle 100. Here, the remote driver who remotely drives the remote driving target vehicle 100 includes a remote driver who is determined in a case where a remote driving request is made from the remote driving target vehicle 100 and a remote driver who is determined in a case where a remote driver change request is made from the remote driver.

Processing in the processor that determines the remote driver who remotely drives the remote driving target vehicle 100 includes first processing of selecting one remote driver group from one or more remote driver groups including at least one remote driver and second processing of selecting one remote driver from the one remote driver group.

### 1-2-1. Determination of Remote Driver Group

Determination of remote driver groups will be described.

Here, the remote driver groups are obtained by classifying all remote drivers into suitable groups in advance in order to efficiently and usefully use all remote drivers. The determination of the remote driver groups is performed referring to information about, for example, registered skills which is a skill set self-reported by each remote driver and evaluation skills which are results of the system evaluating remote driving records in past.

Here, the information about the registered skills is, for example, a history of the work engaged in past, such as engagement in moving an accident vehicle by a camera, engagement in monitoring automated driving by a camera and a LiDAR, or engagement in work of moving a vehicle to a safe place by guidance only with a radar. Moreover, the information about the evaluation skills is information indicating the level of skill in the work contents, which has been evaluated by the system on the basis of the work engaged in the past, and specifically, information such as the total time engaged in, the difficulty of the work, and the level of skill in the work.

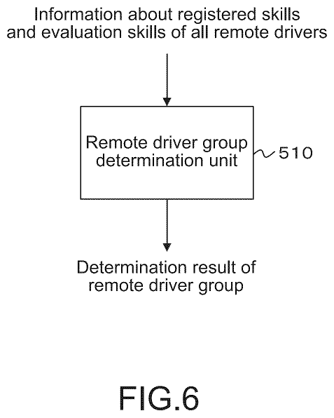

FIG. 6 shows a configuration example of a remote driver group determination unit 510. The remote driver group determination unit 510 inputs information about registered skills and evaluation skills of all remote drivers and outputs a result of determination of the remote driver groups. The remote driver group determination unit 510 determines remote driver groups by, for example, applying non-supervised learning using principal component analysis. In this non-supervised learning, it is possible to divide a large amount of data on the basis of a comprehensive evaluation on the basis of a plurality of arbitrary pre-set evaluation axes.

The remote driver group determination unit 510 determines remote driver groups by applying unsupervised learning using principal component analysis, and for example, it is possible to classify all remote drivers into groups with complex perspectives, such as a group of remote drivers with a lot of experience in avoiding danger using cameras, or a group of remote drivers with a lot of experience in operating automated driving using cameras and LiDAR.

It should be noted that the remote driver group determination unit 510 is not limited to determining the remote driver group by applying the unsupervised learning using principal component analysis, and may determine the remote driver groups using other techniques, for example, using a standard condition judgment algorithm. Moreover, the remote driver group determination unit 510 is not limited to determining the remote driver group on the basis of the information about the registered skills and the evaluation skills of all remote drivers, and may use one of the information about the registered skills and the evaluation skills, or may use other information in addition to this information.

### 1-2-2. Processing in Processor That Determines Remote Driver

The processing in the processor that determines the remote driver includes, as described above, the first processing of selecting one remote driver group from the remote driver groups and the second processing of selecting one remote driver from the one remote driver group.

In the first processing, the one remote driver group is selected on the basis of either one or both of the sensor information and the operation information of the remote driving target vehicle 100. Accordingly, it is possible to select a remote driver group including a remote driver suitable for the surrounding state and the like of the remote driving target vehicle 100.

Here, the sensor information is, for example, information about any one of a vehicle position change over time, a maximum number of vehicles, an average number of vehicles, a minimum vehicle-to-vehicle distance, an average vehicle-to-vehicle distance, a relative speed distribution change over time, a maximum relative speed value, an estimated vehicle type, or a rough vehicle body shape of a surrounding vehicle, a guardrail position, a signal position, or a stop line position, which is acquired by any one of a camera, a radar, or a LiDAR of the remote driving target vehicle 100 or by a combination thereof, or information about any combination thereof.

Moreover, here, the operation information is, for example, information about any one of a speed history, an acceleration history, a steering operation history, an accelerator operation history, a brake operation history, a history of engine revolutions per minute, an engine temperature history, a remaining amount of fuel or battery charge, an estimated load weight value, a vehicle body size, or a vehicle body shape of the remote driving target vehicle 100 or information about any combination thereof.

In the second processing, the one remote driver is selected on the basis of the information related to each remote driver included in the one remote driver group. Accordingly, it is possible to select the best remote driver for remotely driving the remote driving target vehicle 100. Here, the information related to the remote driver is, for example, information about any one of connection information (quality information, delay information), health information, or work information of the remote driver or information about any combination thereof.

It should be noted that the connection information is associated with a connection environment between the remote drivers 400 (the remote driver 400A, the remote driver 400B, the remote driver 400C) and the remote driving system 500. As described above, the communication between the remote drivers 400 and the remote driving system 500 is assumed to be either wired or wireless or both.

Based on the connection information, it is possible to select a remote driver with a good connection environment and perform the remote driving with higher accuracy. Moreover, based on the health information, it is possible to avoid selecting remote drivers under a health condition unsuitable for the remote driving, for example, being currently drunk, having a high body temperature, or having low blood pressure. Moreover, based on the work information, it is possible to avoid selecting, for example, a remote driver currently engaged in other remote driving.

### 1-2-3. Configuration Example of Processor that Determines Remote Driver

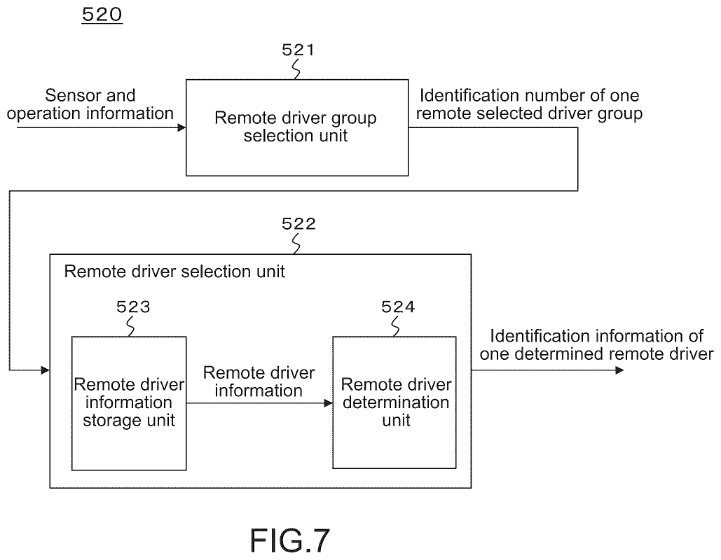

FIG. 7 shows a configuration example of a processor 520 that determines the remote driver described above. The processor 520 includes a remote driver group selection unit 521 and a remote driver selection unit 522.

The remote driver group selection unit 521 is a part that performs the above-mentioned first processing. The remote driver group selection unit 521 inputs either one or both of the sensor information and the operation information of the remote driving target vehicle 100 and outputs an identification number of one remote driver group selected.

In the remote driver group selection unit 521, supervised learning using data prepared in advance is performed in advance. By this supervised learning, a processing system capable of performing high-performance classification on a wide variety of information, such as the sensor information and the operation information, is obtained. The remote driver group selection unit 521 is assumed to be configured by, for example, a deep learning network.

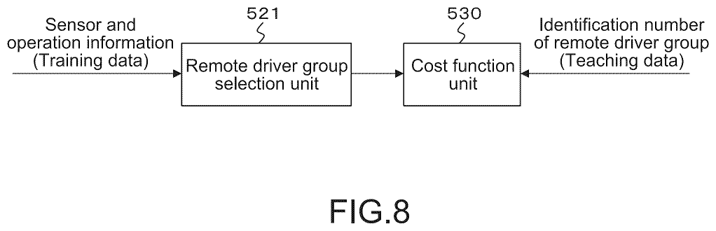

FIG. 8 shows an example of supervised learning for configuring the remote driver group selection unit 521. First of all, a large number of combinations of the sensor information and the operation information collected in advance and the identification numbers of the remote driver groups that should be selected when such data is input are prepared.

Next, regarding the input of the remote driver group selection unit 521, the sensor information and the operation information are input as input data, and the output at that time and the identification number of the remote driver group corresponding to the input data are input to a cost function unit 530 that evaluates a difference. At this time, optimization is performed using backpropagation, adjusting the weight of each network in the remote driver group selection unit 521 so that the magnitude of the error indicated by the cost function value calculated by the cost function unit 530 is reduced.

It should be noted that the cost function value in this case may be the sum of the average squared errors for all data between the output of the remote driving group selection unit 530 and the remote driver group identification numbers of teaching data, or it may be the sum of the average squared errors plus some term for the purpose of regularization.

Referring back to FIG. 7, the remote driver selection unit 522 is a part that performs the above-mentioned second processing. The remote driver selection unit 522 inputs the identification number of the one remote driver group selected by the remote driver group selection unit 521 and outputs the identification information (identification number, name, etc.) of one remote driver determined.

The remote driver selection unit 522 includes a remote driver information storage unit 523 and a remote driver determination unit 524. The remote driver information storage unit 523 configures a database and stores information related to each remote driver included in each of all remote driver groups, for example, connection information (quality information, delay information), health information, work information, and the like.

The remote driver selection unit 522 extracts, from the remote driver information storage unit 523, remote driver information of each remote driver included in the remote driver group corresponding to the identification number of the one remote driver group input. The remote driver information of each remote driver includes the identification information (identification number, name, etc.) of each remote driver and the information related to the remote driver (connection information, health information, work information, etc.), which are associated with the identification information of each remote driver. The remote driver information of each remote driver included in the remote driver group corresponding to the identification number of the one remote driver group input, which is extracted from the remote driver information storage unit 523 in this manner, is input to the remote driver determination unit 524.

The remote driver determination unit 524 determines the best remote driver among the respective remote drivers included in the remote driver group corresponding to the identification number of the one remote driver group input by referring to the information related to each remote driver (connection information, health information, work information, etc.). In this case, remote drivers under a health condition unsuitable for the remote driving, for example, being currently drunk, having a high body temperature, or having low blood pressure, are excluded on the basis of, for example, the health information. In this case, remote drivers currently engaged in other remote driving are also excluded on the basis of, for example, the work information. Moreover, in this case, for example, if there is a plurality of remote drivers who have no problems with the health and working conditions, a remote driver with the best connection environment is determined.

### 1-2-4. Processing Steps of Remote Driver Selection Unit

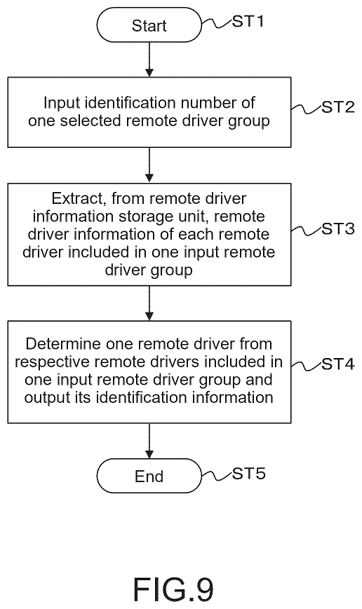

The flowchart in FIG. 9 shows an example of processing steps of the remote driver selection unit 522. First of all, the remote driver selection unit 522 starts the processing in Step ST1. Then, in Step ST2, the remote driver selection unit 522 inputs the identification number of one remote driver group selected by the remote driver group selection unit 521.

Then, in Step ST3, the remote driver selection unit 522 extracts, from the remote driver storage unit 523, remote driver information of each remote driver included in the remote driver group corresponding to the identification number of the one remote driver group input. Then, in Step ST4, the remote driver selection unit 522 determines one remote driver from the respective remote drivers included in the remote driver group corresponding to the identification number of the one remote driver group input through the remote driver determination unit 524 by referring to the information related to each remote driver (connection information, health information, work information, etc.), and outputs its identification information (identification number, name, etc.). Then, in Step ST5, the remote driver selection unit 522 terminates the processing.

### 1-2-5. Processing Steps in System Configuration Example

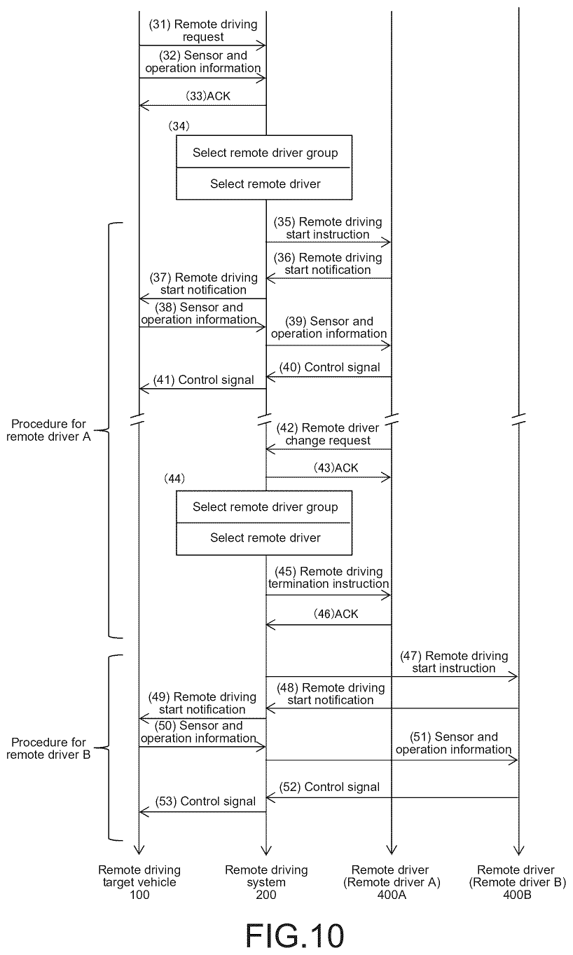

FIG. 10 is a sequence diagram showing an example of processing steps in the system configuration example shown in FIGS. 4 and 5. The example shown in the figure is an example in which the remote driving is started by sending a remote driving request from the remote driving target vehicle 100 to the remote driving system 500. It should be noted that an operation state of the remote driving target vehicle 100 may be analyzed by the remote driving system 500 as appropriate and the remote driving may be started on the basis of the judgement result or the remote driving may be started at a timing preset on the basis of an operation plan to perform the remote driving.

The sequence diagram in FIG. 10 will be described. First of all, a case where the remote driving is started will be described. (31) The remote driving target vehicle 100 sends a remote driving request to the remote driving system 500. In this case, the remote driving target vehicle 100 is, for example, an unmanned vehicle without a driver, and if a situation that interferes with the continuation of automatic driving occurs, the remote driving target vehicle 100 detects it and automatically sends to a remote driving request to the remote driving system 500.

It should be noted that there may be a case where the remote driving target vehicle 100 is a manned vehicle with a driver, and in this case, for example, if the driver encounters an accident that interferes with the continuation of the driving, the remote driving target vehicle 100 may detect it and send a remote driving request to the remote driving system 500 automatically or by the driver operating it by him/herself.

(32) Then, the remote driving target vehicle 100 continuously sends the sensor information and the operation information to the remote driving system 500. (33) Subsequently, the remote driving system 500 that has received the remote driving request, and the sensor information and the operation information sends ACK back to the remote driving target vehicle 100.

(34) Subsequently, the remote driving system 500 selects one remote driver group from one or more remote driver groups including at least one remote driver on the basis of either one or both of the sensor information and the operation information and also selects one remote driver from the one remote driver group, thereby determining the remote driver who should perform the remote driving (see the processor 520 in FIG. 7). It should be noted that hereinafter, the description will be continued assuming that the remote driver 400A is determined.

(35) Subsequently, the remote driving system 500 sends a remote driving start instruction to the remote driver 400A (actually the terminal apparatus used by the remote driver 400A). (36) Subsequently, the remote driver 400A that has received the remote driving start instruction sends a remote driving start notification to the remote driving system 500. (37) Subsequently, the remote driving system 500 that has received the remote driving start notification transfers the remote driving start notification to the remote driving target vehicle 100.

(38) Subsequently, the remote driving target vehicle 100 that has received the remote driving start notification sends the sensor information and the operation information to the remote driving system 500. (39) Subsequently, the remote driving system 500 that has received the sensor information and the operation information transfers the sensor information and the operation information to the remote driver 400A. This enables the remote driver 400A to obtain the video footages, the distance measurement information of the surrounding environment, and the like from the vehicle through the sensors, such as cameras, radars, and LiDARs, provided in the remote driving target vehicle 100, for example.

(40) Subsequently, the remote driver 400A performs a remote driving operation by using the video footages, the distance measurement information of the surrounding environment, and the like from the vehicle, and sends a control signal based on it to the remote driving system 500. (41) Subsequently, the remote driving system 500 that has received the control signal from the remote driver 400A transfers the control signal to the remote driving target vehicle 100. Accordingly, the remote driver 400A performs the remote driving operation on the remote driving target vehicle 100.

Thereafter, although the illustration is omitted, the remote driver 400A receives the sensor information and the operation information from the remote driving target vehicle 100 via the remote driving system 500, and the remote driver 400A sends the control signal based on the remote driving operation to the remote driving target vehicle 100 via the remote driving system 500. Those operations are repeatedly performed. In this manner, the remote driver 400A continuously performs the remote driving of the remote driving target vehicle 100.

It should be noted that the sensor information sent from the remote driving target vehicle 100 to the remote driving system 500 can be summarized information or information thinned out in terms of time or it is also possible to compress the amount of data as information with the amount of data adjusted to be adapted to a scene.

Here, summarizing the sensor information means extracting only necessary information from the sensor information and compressing the amount of data. For example, as a summary of the sensor information, it is possible to recognize objects such as vehicles and obstacles from camera information and obtain information about the contents of those objects and position information of those objects.

Moreover, thinning out sensor information in terms of time means, for example, not sending all of the sensor information obtained in a certain cycle, but sending only every few pieces of the sensor information. In this case, the thinning ratio is fixed.

Moreover, adjusting the sensor information to the amount of data adapted to the scene means, for example, thinning out the sensor information obtained at a certain cycle by changing the ratio according to the scene. Moreover, the scene refers to, for example, whether it is a public road or an expressway, or whether it is acceleration driving or constant speed driving, and in scenes where the sensor information may be coarse in terms of time, the ratio of thinning out in terms of time is increased and the amount of data is adjusted to be small.

Here, only one of summarizing, thinning out in terms of time, and adjusting to the amount of data adapted to the scene can be applied or more than one of them may be applied in combination.

Although the operation information sent from the remote driving target vehicle 100 to the remote driving system 500 has a smaller amount of data than the above-mentioned sensor information, its amount of data can also be compressed, for example, as summarized information to be information with higher convenience.

Moreover, the sensor information and the operation information of the remote driving target vehicle 100 in the remote driving of the remote driver 400A may be shared with the remote driver group including the remote driver 400A. In this case, the remote driving system 500 transfers the sensor information and the operation information sent from the remote driving target vehicle 100 also to other remote drivers included in the remote driving group including the remote driver 400A. This enables the other remote drivers included in the remote driving group including the remote driver 400A to easily know a remote driving state of the current remote driver 400A, and to, for example, when taking over the remote driving, quickly know the remote driving state and smoothly take it over. In this case, the sensor information and the operation information may be the summarized information. By this summarizing, it is possible to present the remote driving state to the remote drivers in an easier way to understand.

Next, a case of changing the remote driver will be described. Here, a case where the remote driver 400A wishes to change the remote driver and another remote driver takes over the role is considered. (42) In this case, the remote driver 400A sends a remote driver change request to the remote driving system 500. (43) Subsequently, the remote driving system 500 that has received the remote driver change request sends ACK back to the remote driver 400A.

(44) Subsequently, on the basis of either one or both of the sensor information and the operation information sent from the remote driving target vehicle 100, the remote driving system 500 selects one remote driver group from one or more remote driver groups including at least one remote driver and also selects one remote driver from the one remote driver group, thereby determining the remote driver who should the remote driving (see the processor 520 in FIG. 7). Hereinafter, the description will be continued assuming that the remote driver 400B is determined.

In this case, the remote driving system 500 has already acquired the sensor information and the operation information from the remote driving target vehicle 100. Therefore, the remote driver group for changing the remote driver can be relatively quickly selected on the basis of that information.

It should be noted that here, one remote driver group is selected from one or more remote driver groups including at least one remote driver, one remote driver is selected from the one remote driver group, and the remote driver who should the remote driving is determined. However, in a case of changing the remote driver, it may be desirable to determine the remote driver who should take it over from the remote driver group including the remote driver 400A who is currently performing the remote driving. In that case, it is possible to omit the selection of the remote driver group and determine the remote driver who should take it over from the remote driver group including the remote driver 400A.

Moreover, here, in a case where a remote driver change request is made from the remote driver 400A currently performing the remote driving, one remote driver group is selected from one or more remote driver groups including at least one remote driver, one remote driver is selected from the one remote driver group, and the remote driver who should the remote driving is determined. However, during the remote driving of the remote driver 400A, it is also possible to determine appropriate candidate remote drivers who should take it over in advance and to reflect a result of determination made in advance in a case where a remote driver change request is made from the remote driver 400A. Accordingly, it is possible to change the remote driver more smoothly.

(45) Subsequently, the remote driving system 500 sends a remote driving termination instruction to the remote driver 400A. (46) Subsequently, the remote driver 400A that has received the remote driving termination instruction sends ACK back to the remote driving system 500.

(47) Subsequently, the remote driving system 200 that has received the ACK from the remote driver 400A sends a remote driving start instruction to the remote driver 400B. (48) Subsequently, the remote driver 400B that has received the remote driving start instruction sends a remote driving start notification to the remote driving system 500. (49) Subsequently, the remote driving system 500 that has received the remote driving start notification transfers the remote driving start notification to the remote driving target vehicle 100. (50) Subsequently, the remote driving target vehicle 100 that has received the remote driving start notification sends the sensor information and the operation information to the remote driving system 500.

(51) Subsequently, the remote driving system 500 that has received the sensor information and the operation information transfers the sensor information and the operation information to the remote driver 400B. This enables the remote driver 400B to obtain the video footages, the distance measurement information of the surrounding environment, and the like from the vehicle through the sensors, such as cameras, radars, and LiDARs, provided in the remote driving target vehicle 100, for example.

(52) Subsequently, the remote driver 400B performs a remote driving operation by using the video footages, the distance measurement information of the surrounding environment, and the like from the vehicle, and sends a control signal based on it to the remote driving system 500. (53) Subsequently, the remote driving system 500 that has received the control signal from the remote driver 400B transfers the control signal to the remote driving vehicle 100. Accordingly, the remote driver 400B performs the remote driving operation on the remote driving target vehicle 100.

Thereafter, although the illustration is omitted, the remote driver 400B receives the sensor information and the operation information from the remote driving target vehicle 100 via the remote driving system 500, and the remote driver 400B sends the control signal based on the remote driving operation to the remote driving target vehicle 100 via the remote driving system 500. Those operations are repeatedly performed. In this manner, the remote driver 400B continuously performs the remote driving of the remote driving target vehicle 100.

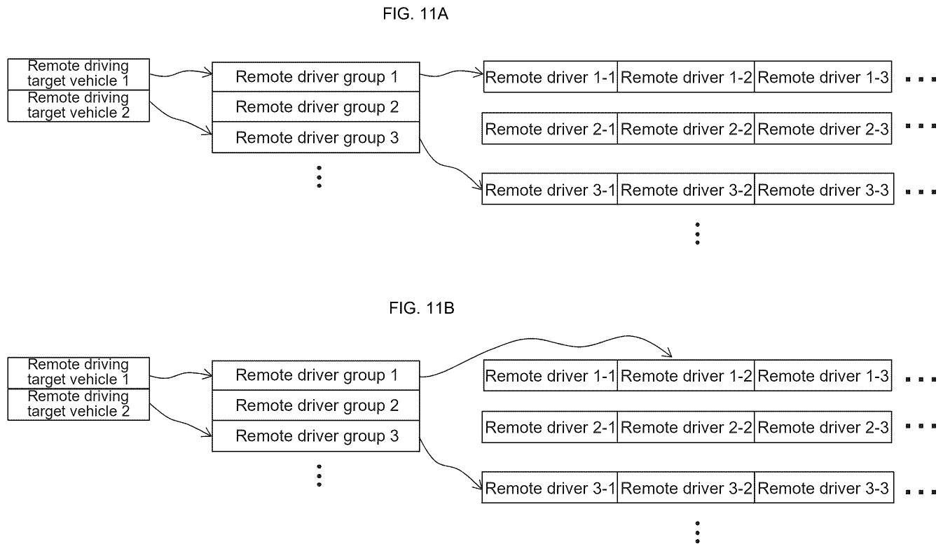

FIG. 11 shows a remote driver change example due to a remote driver change. (a) of FIG. 11 shows a state before the remote driver change. A remote driver of a remote driving target vehicle 1 is a remote driver 1-1 in a remote driver group 1. Moreover, a remote driver of a remote driving target vehicle 2 is a remote driver 3-1 in a remote driver group 3. (b) of FIG. 11 shows a state after the remote driver change. The remote driver of the remote driving target vehicle 1 is changed to a remote driver 1-2 in the remote driver group 1. Moreover, the remote driver of the remote driving target vehicle 2 is still the remote driver 3-1 in the remote driver group 3.

In a case where the remote driver is changed in the same remote driver group in this manner, sharing the sensor information and the operation information in the remote driving in the remote driver group or summarizing them enables a remote driver who has taken over to quickly get the remote driving state and smoothly start the remote driving.

### 1-2-6. Hardware Configuration Example of Remote Driving System

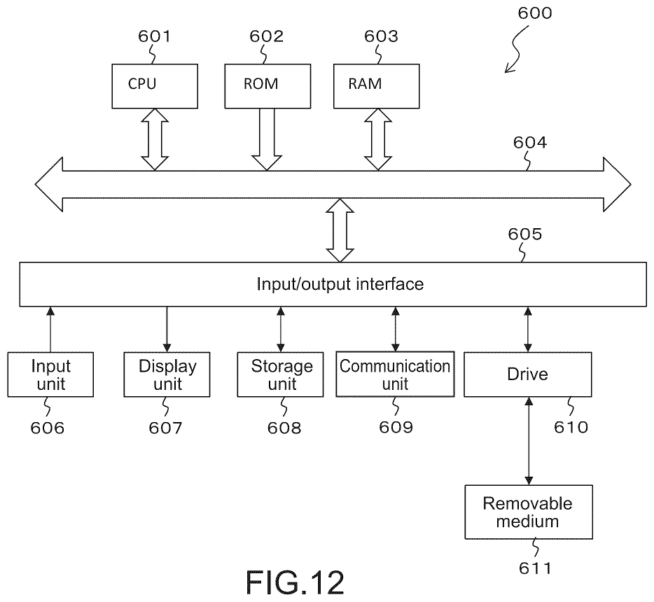

FIG. 12 is a block diagram showing a hardware configuration example of a computer 600 that configures the remote driving system 500.

In the computer 600, a central processor (CPU) 601, a read only memory (ROM) 602, and a random access memory (RAM) 603 are connected to one another via a bus 604.

An input/output interface 605 is further connected to the bus 604. An input unit 606, an output unit 607, a recording unit 608, a communication unit 609, and a drive 610 are connected to the input/output interface 605.

The input unit 606 is constituted by an input switch, a button, a microphone, an imaging element, and the like. The output unit 607 is constituted by a display, a loudspeaker, and the like. The recording unit 608 is constituted by a hard disk, a nonvolatile memory, and the like. The communication unit 609 is constituted by a network interface and the like. The drive 610 drives a removable recording medium 611, such as a magnetic disk, an optical disc, a magneto-optical disk, or a semiconductor memory.

In the computer 600, the above-mentioned series of processing is performed by the CPU 601 loading and executing a program recorded in the recording unit 608, for example, to the RAM 603 via the input/output interface 605 and the bus 604.

The program executed by the computer 600 (CPU 601) can be provided, recorded on the removable recording medium 611 as a package medium, for example. Moreover, the program can be provided via a wired or wireless transmission medium, such as a local area network, the Internet, and digital satellite broadcasting.

In the computer 600, the program can be installed in the recording unit 608 via the input/output interface 605 by mounting the removable recording medium 611 on the drive 610. Moreover, the program can be received by the communication unit 609 and installed in the recording unit 608 via the wired or wireless transmission medium. Otherwise, the program can be installed in the ROM 602 or the recording unit 608 in advance.

In the system configuration for performing remote driving as shown in FIGS. 4 and 5, the remote driving system 500 includes the processor that determines the remote driver who remotely drives the remote driving target vehicle 100, and the processing in this processor includes first processing of selecting one remote driver group from one or more remote driver groups including at least one remote driver and second processing of selecting one remote driver from the one remote driver group. It is possible to favorably determine the remote driver, rather than directly determining one remote driver from a large number of remote drivers.

### 2. Modified Example

### 2-1. Application to Case of Remotely Driving Vehicle Group

It should be noted that in the above-mentioned embodiment, the example in which the one remote driver remotely drives a single remote driving target vehicle has been described.

However, the present technology can also be applied to a case where the one remote driver remotely drives one vehicle group constituted by a plurality of target remote vehicles traveling in a convoy (tandem traveling). In this case, the plurality of target remote vehicles traveling in a convoy are remotely driven together for some reason, such as having the same purpose, being of the same vehicle type, or heading to the same destination.

In this case, the respective remote driving target vehicles included in the vehicle group are connected by, for example, vehicle-to-vehicle communication, and configured to travel in a convoy. Therefore, by sending the control signal associated with the remote driving from the remote driver only to a representative vehicle, for example, the remote driving of the respective remote driving target vehicles included in the vehicle group is executed.

In this manner, the sensor information and the operation information used when selecting the remote driver group in a case where the remote driving target is the vehicle group are set to, for example, typical values of the sensor information and the operation information of the plurality of remote driving target vehicles included in the vehicle group. Here, the typical value is, for example, a minimum value, a maximum value, an average value, a median value, a mode value, or the like. It should be noted that sensor information and operation information of a representative vehicle or a selected predetermined vehicle may be used as the sensor information and the operation information used when selecting the remote driver group in a case where the remote driving target is the vehicle group.

### 2-2. Remote Driving Start Due to Driving Abnormality Detection of Remote Driving Vehicle

Moreover, in the above-mentioned embodiment, the example in which the remote driving is started by sending the remote driving request from the remote driving target vehicle 100 to the remote driving system 500 has been described. However, it is also possible to employ a configuration in which the remote driving system 500 detects an abnormality in the driving of the remote driving target vehicle 100 on the basis of the sensor information and the operation information sent from the remote driving target vehicle 100, such that the remote driving is started.

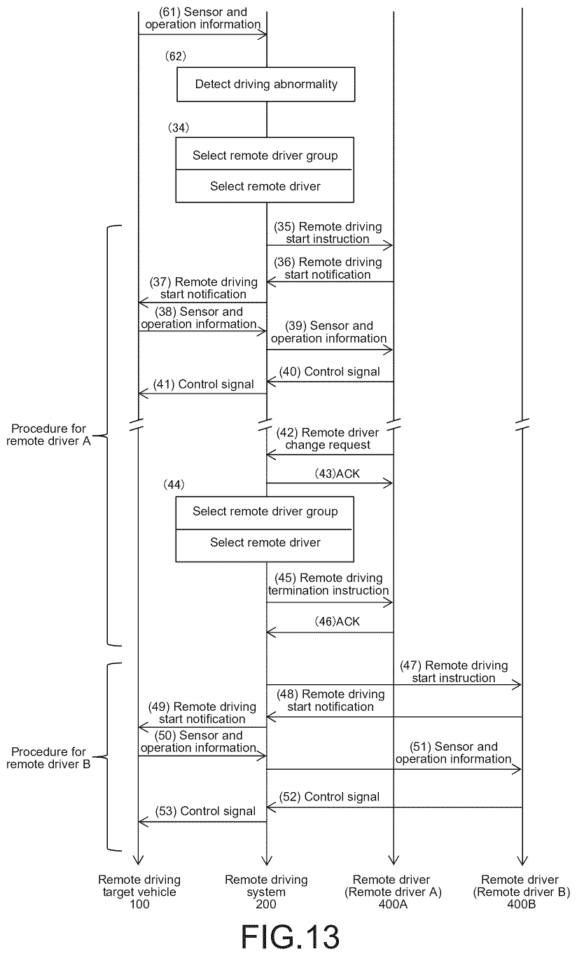

FIG. 13 is a sequence diagram showing an example of processing steps in the system configuration example shown in FIGS. 4 and 5 in that case. In this case, (61) the remote driving target vehicle 100 repeatedly sends the sensor information and the operation information to the remote driving system 500 during the automated driving or during the driving of the driver in the vehicle. Accordingly, the remote driving system 500 is capable of observing a driving state of the remote driving target vehicle 100 on the basis of the sensor information and the operation information.

(62) When the remote driving system 500 detects an abnormality in the driving and judges that the remote driving is necessary as a result of observing the driving state of the remote driving target vehicle 100, then (34) the remote driving system 500 selects one remote driver group from one or more remote driver groups including at least one remote driver on the basis of either one or both of the sensor information and the operation information, also selects one remote driver from the one remote driver group, thereby determining the remote driver who should the remote driving (see the processor 520 in FIG. 7), and causes the remote driver to start the remote driving of the remote driving target vehicle 100.

The subsequent processing steps in the sequence diagram in FIG. 13 are the same as the processing steps in the sequence diagram in FIG. 10, so the description will be omitted.

Moreover, although the favorable embodiments of the present disclosure have been described above in detail with reference to the accompanying drawings, the technical scope of the present disclosure is not limited to such examples. It is obvious that a person having an ordinary skill in the art of the present disclosure can conceive various variants or modifications within the scope of the technical ideas described in the scope of claims, and it should be understood that these variants or modifications also fall within the technical scope of the present disclosure as a matter of course.

In addition, the effects described in this specification are merely illustrative or exemplary and not limitative. That is, in addition to or instead of the above-mentioned effects, the technology according to the present disclosure can provide other effects obvious to a person skilled in the art in light of the descriptions in this specification.

Moreover, the present technology can also take configurations as follows.
(1) A remote driving system, including
a processor that determines a remote driver who remotely drives a remote driving target vehicle, in which
processing in the processor includes first processing of selecting one remote driver group from one or more remote driver groups including at least one remote driver and second processing of selecting one remote driver from the one remote driver group.
(2) The remote driving system according to (1), in which
sensor information and operation information of the remote driving target vehicle at a time of remote driving of a remote driver determined in the processor is shared with a remote driving group including the remote driver.
(3) The remote driving system according to (1) or (2), in which
in the first processing, the one remote driver group is selected on the basis of either one or both of sensor information and operation information of the remote driving target vehicle.
(4) The remote driving system according to (3), in which
when the remote driving target vehicle includes a plurality of remote driving target vehicles, a typical value of sensor information of the plurality of remote driving target vehicles is used as the sensor information.
(5) The remote driving system according to (3) or (4), in which
when the remote driving target vehicle includes a plurality of remote driving target vehicles, a typical value of operation information of the plurality of remote driving target vehicles is used as the operation information.
(6) The remote driving system according to any one of (3) to (5), in which
the sensor information is information about any one of a vehicle position change over time, a maximum number of vehicles, an average number of vehicles, a minimum vehicle-to-vehicle distance, an average vehicle-to-vehicle distance, a relative speed distribution change over time, a maximum relative speed value, an estimated vehicle type, or a rough vehicle body shape of a surrounding vehicle, a guardrail position, a signal position, or a stop line position, which is acquired by any one of a camera, a radar, or a LiDAR of the remote driving target vehicle or by a combination thereof, or information about any combination thereof.
(7) The remote driving system according to any one of (3) to (6), in which
the operation information is information about any one of a speed history, an acceleration history, a steering operation history, an accelerator operation history, a brake operation history, a history of engine revolutions per minute, an engine temperature history, a remaining amount of fuel or battery charge, an estimated load weight value, a vehicle body size, or a vehicle body shape of the remote driving target vehicle or information about any combination thereof.
(8) The remote driving system according to any one of (1) to (7), in which
in the second processing, the one remote driver is selected on the basis of information related to each remote driver included in the one remote driver group.
(9) The remote driving system according to (8), in which
the information related to the remote driver is information about any one of connection information, health information, or work information of the remote driver or information about any combination thereof.
(10) The remote driving system according to any one of (1) to (9), in which
the processor determines, when a remote driving request is made from the remote driving target vehicle, a remote driver who remotely drives the remote driving target vehicle.
(11) The remote driving system according to any one of (1) to (9), in which
the processor determines, when an abnormality in driving of the remote driving target vehicle is detected, a remote driver who remotely drives the remote driving target vehicle.
(12) The remote driving system according to any one of (1) to (11), in which
the processor determines, when a remote driver change request is made from a first remote driver who is remotely driving the remote driving target vehicle, a second remote driver that remotely drives the remote driving target vehicle.
(13) The remote driving system according to (12), in which
the processor performs the first processing of selecting one remote driver group from one or more remote driver groups including at least one remote driver and the second processing of selecting one remote driver from the one remote driver group, thereby determining the second remote driver.
(14) The remote driving system according to (12), in which
the processor performs, when the first remote driver has been determined by performing the first processing of selecting one remote driver group from one or more remote driver groups including at least one remote driver and the second processing of selecting one remote driver from the one remote driver group, processing of selecting one remote driver different from the first remote driver from the remote driver group including the first remote driver, thereby determining the second remote driver.
(15) An information processing apparatus, including:
a first processor that selects one remote driver group from one or more remote driver groups including at least one remote driver; and
a second processor that selects one remote driver from the one remote driver group.
(16) The information processing apparatus according to (15), in which
in the first processor, the one remote driver group is selected on the basis of either one or both of sensor information and operation information of a remote driving target vehicle.
(17) The information processing apparatus according to (15) or (16), in which
in the second processor, the one remote driver is selected on the basis of information related to each remote driver included in the one remote driver group.
(18) An information processing method, including:
a step of selecting one remote driver group from one or more remote driver groups including at least one remote driver; and
a step of selecting one remote driver from the one remote driver group.

### REFERENCE SIGNS LIST

100 remote driving target vehicle
400A, 400B, 400C remote driver
500 remote driving system
510 remote driver group determination unit
520 processor
521 remote driver group selection unit
522 remote driver selection unit
523 remote driver information storage unit
524 remote driver determination unit
530 cost function unit

1. A remote driving system, comprising
a processor that determines a remote driver who remotely drives a remote driving target vehicle, wherein
processing in the processor includes first processing of selecting one remote driver group from one or more remote driver groups including at least one remote driver and second processing of selecting one remote driver from the one remote driver group.

2. The remote driving system according to claim 1, wherein
sensor information and operation information of the remote driving target vehicle at a time of remote driving of a remote driver determined in the processor is shared with a remote driving group including the remote driver.

3. The remote driving system according to claim 1, wherein
in the first processing, the one remote driver group is selected on a basis of either one or both of sensor information and operation information of the remote driving target vehicle.

4. The remote driving system according to claim 3, wherein
when the remote driving target vehicle comprises a plurality of remote driving target vehicles, a typical value of sensor information of the plurality of remote driving target vehicles is used as the sensor information.

5. The remote driving system according to claim 3, wherein
when the remote driving target vehicle comprises a plurality of remote driving target vehicles, a typical value of operation information of the plurality of remote driving target vehicles is used as the operation information.

6. The remote driving system according to claim 3, wherein
the sensor information is information about any one of a vehicle position change over time, a maximum number of vehicles, an average number of vehicles, a minimum vehicle-to-vehicle distance, an average vehicle-to-vehicle distance, a relative speed distribution change over time, a maximum relative speed value, an estimated vehicle type, or a rough vehicle body shape of a surrounding vehicle, a guardrail position, a signal position, or a stop line position, which is acquired by any one of a camera, a radar, or a LiDAR of the remote driving target vehicle or by a combination thereof, or information about any combination thereof.

7. The remote driving system according to claim 3, wherein
the operation information is information about any one of a speed history, an acceleration history, a steering operation history, an accelerator operation history, a brake operation history, a history of engine revolutions per minute, an engine temperature history, a remaining amount of fuel or battery charge, an estimated load weight value, a vehicle body size, or a vehicle body shape of the remote driving target vehicle or information about any combination thereof.

8. The remote driving system according to claim 1, wherein
in the second processing, the one remote driver is selected on a basis of information related to each remote driver included in the one remote driver group.

9. The remote driving system according to claim 8, wherein
the information related to the remote driver is information about any one of connection information, health information, or work information of the remote driver or information about any combination thereof.

10. The remote driving system according to claim 1, wherein
the processor determines, when a remote driving request is made from the remote driving target vehicle, a remote driver who remotely drives the remote driving target vehicle.

11. The remote driving system according to claim 1, wherein
the processor determines, when an abnormality in driving of the remote driving target vehicle is detected, a remote driver who remotely drives the remote driving target vehicle.

12. The remote driving system according to claim 1, wherein
the processor determines, when a remote driver change request is made from a first remote driver who is remotely driving the remote driving target vehicle, a second remote driver that remotely drives the remote driving target vehicle.

13. The remote driving system according to claim 12, wherein
the processor performs the first processing of selecting one remote driver group from one or more remote driver groups including at least one remote driver and the second processing of selecting one remote driver from the one remote driver group, thereby determining the second remote driver.

14. The remote driving system according to claim 12, wherein
the processor performs, when the first remote driver has been determined by performing the first processing of selecting one remote driver group from one or more remote driver groups including at least one remote driver and the second processing of selecting one remote driver from the one remote driver group, processing of selecting one remote driver different from the first remote driver from the remote driver group including the first remote driver, thereby determining the second remote driver.

15. An information processing apparatus, comprising:
a first processor that selects one remote driver group from one or more remote driver groups including at least one remote driver; and
a second processor that selects one remote driver from the one remote driver group.

16. The information processing apparatus according to claim 15, wherein
in the first processor, the one remote driver group is selected on a basis of either one or both of sensor information and operation information of a remote driving target vehicle.

17. The information processing apparatus according to claim 15, wherein
in the second processor, the one remote driver is selected on a basis of information related to each remote driver included in the one remote driver group.

18. An information processing method, comprising:
a step of selecting one remote driver group from one or more remote driver groups including at least one remote driver; and
a step of selecting one remote driver from the one remote driver group.
